(19) United States
(12) Patent Application Publication
(10) Pub. No.: US 2021/0024265 A1
(43) Pub. Date: Jan. 28, 2021

(54) AFFORDANCE FOR USE ON AN ITEM IN A CONTAINER

(71) Applicant: Ocado Innovation Limited, Hatfield, Hertfordshire (GB)

(72) Inventors: Duncan RUSSELL, Hatfield, Hertfordshire (GB); Panagiotis SOTIROPOULOS, Hatfield, Hertfordshire (GB)

(73) Assignee: Ocado Innovation Limited, Hatfield, Hertfordshire (GB)

(21) Appl. No.: 17/046,254

(22) PCT Filed: Apr. 1, 2019
(86) PCT No.: PCT/EP2019/058176

§ 371 Date: Oct. 8, 2020

(30) Foreign Application Priority Data
Apr. 9, 2018 (GB) 1805841.2

(51) Int. Cl. B65D 63/18; B65G 1/137

(52) U.S. Cl. CPC B65D 63/18; B65G 1/137

(57) ABSTRACT

The present disclosure provides an affordance for an item to be stored in a container such that an easier grasp can be made on an item to be removed from the container. A support is arranged to support at least a portion of the item to be grasped and a grasping device is arranged to be grasped. A storage system having first and second sets of parallel rails or tracks forms a grid pattern, a plurality of stacks of containers being located beneath the rails, and arranged such that each stack is located within a footprint of a single grid space. A transporting device is arranged to move in X and/or Y directions, above the stacks. A container can contain at least one item and at least one affordance is installed on the item.

This application claims priority from UK Patent Application No. 1805841.2 filed 9 Apr. 2018, the content of all this application hereby being incorporated by reference.

### TECHNICAL FIELD

The present invention relates generally to the field of affordances and more specifically to an affordance for use on an item stored in a container.

### BACKGROUND

In the field of storage, higher density storage is desirable, permitting the storage of more items in a smaller space. Higher density storage of items has been facilitated by the use of standardised containers or trays, such as the International Fruit Container, IFCO. An IFCO permits the transport of items in a manner which maximises space and densely packs items stored therein. To maximise the number of items stored in a container (such as an IFCO tray) then the items to be stored in the container should tessellate to thereby minimise the gaps between items. Typically, identical types of items are stored in the same container, however, this need not be the case.

FIG. 1 shows an example of an item 100 which may be stored in a container. As will be appreciated the item 100 may be any type of item suitable for storing in a container such as a grocery product, an electrical item etc. As can be seen, the item 100 tessellates with itself so that multiple items of the type item 100 can pack densely in a container. FIG. 2 shows an example container 200 arranged to store the item 100. In this example, the items are densely packed in the container 200 to thereby maximise the space available in the container 200. As can be seen, there are only small gaps between the items 100 and small gaps between the items 100 on the edge of the container 200 and the walls of the container 200. Although not shown, the items 100 may be arranged in multiple layers to ensure the maximum volume of the container 200 is occupied with the items 100. In this example, two layers of items 100 are stored in the container 100, although only the top layer is shown.

Typically, the container 200 will be loaded with items 100 by a manufacturer of products for shipment to a customer/reseller of the items 100. In this way, the manufacturer can produce multiple items 100 and the reseller may re-sell individual items 100 to final customers and/or customers may purchase multiple items 100 in one order—such as where the item 100 is a disposable/replaceable product such as a box of cereal.

However, the dense packing of items 100 in a container, although maximising the space available in the container leading to minimised storage and transportation costs, results in a problem concerning the unpacking of such a container 200. In particular, grasping a first item 100 from the container 200 can be difficult because there is no position in which an easy and effective grasp can be made to slide/push/pull the item 100 out of the container 200, because there are small gaps between items. For example, humans may employ a single finger to squeeze into a small gap between an item 100 and a wall of a container 200. The human may rely on friction between the single finger and the item 100 to pull the item 100 out of the container 200. However, such a maneuver may be difficult, especially for those people with reduced mobility. Moreover, this may result in excessive force being applied to an item 100 and thereby damaging the item 100.

This problem is reduced after the first item 100 is removed because the space created by the removal of the first item 100 allows effective sliding/pushing/pulling/tilting of subsequent items from the container 200. However, once the first layer of items 100 is removed from the container, the problem re-presents itself concerning the second layer of items 100, again, making it difficult to remove the first item 100 from a layer of items in the container 200.

This problem is particularly apparent when robot systems are used to remove items from the container 200 because the robot system is typically not as dextrous as a human hand and therefore is unable to use any small gaps between the items/walls of the container 200 to lever items 100 out of the container.

One solution to this problem, employed by humans and robot systems alike, is to invert the container and utilise gravity to cause all of the items 100 to fall out of the container 200. However, this risks damaging the items 100.

### SUMMARY

In view of the problems in known item picking, the present invention aims to provide an affordance for an item stored in a container such that an easier grasp can be made on an item to be removed from the container.

According to the present invention there is provided an affordance for an item to be grasped, the item arranged to be stored in a container. The affordance comprises a supporting means arranged to support at least a portion of the item to be grasped and a grasping means arranged to be grasped.

The present invention also provides a storage system comprising a first set of parallel rails or tracks extending in an X-direction, and a second set of parallel rails or tracks extending in a Y-direction transverse to the first set in a substantially horizontal plane to form a grid pattern comprising a plurality of grid spaces, a plurality of stacks of containers located beneath the rails, and arranged such that each stack is located within a footprint of a single grid space, and at least one transporting device according to any preceding claim, the at least one transporting device being arranged to move in the X and/or Y directions, above the stacks. A container of the plurality of stacks of containers is arranged to contain at least one item and at least one affordance as previously described, the at least one affordance is installed on the at least one item.

The present invention also provides a method of using an affordance comprising a supporting means and a grasping means, the affordance is installed on an item to be grasped, the item arranged to be stored in a container. The method comprises the steps of moving the grasping means from a contracted position to an extended position, and grasping the affordance by way of the grasping means.

### BRIEF DESCRIPTION OF THE DRAWINGS

Embodiments of the invention will now be described by way of example only with reference to the accompanying drawings, in which like reference numbers designate the same or corresponding parts, and in which:

FIG. 1 is a schematic diagram of an item.

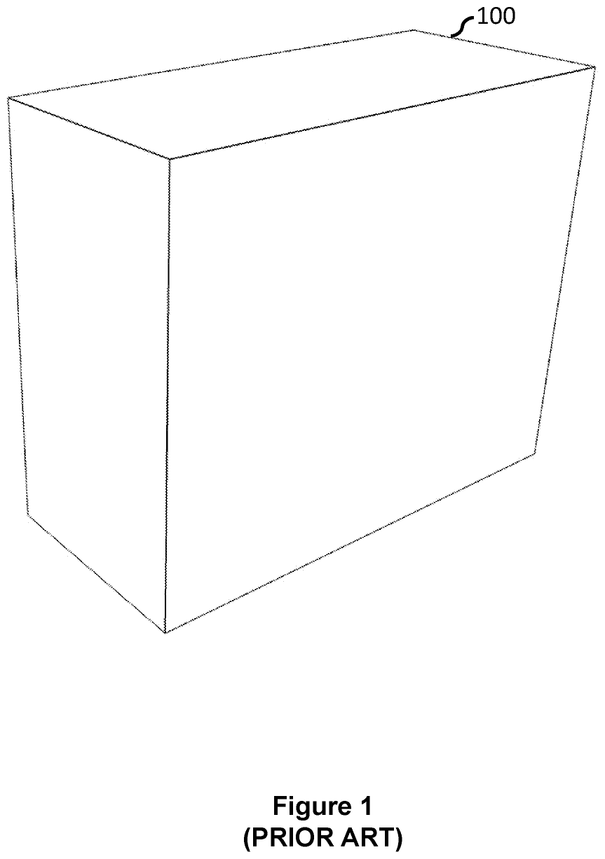

FIG. 2 is a schematic diagram of the item of FIG. 1 located in a container.

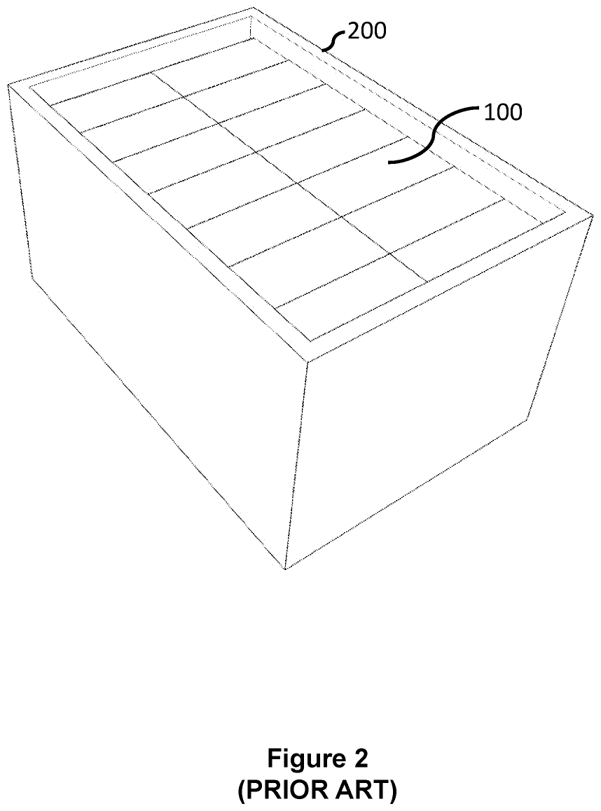

FIG. 3 shows an affordance according to a first embodiment of the present invention.

FIG. 4 shows the affordance according to the first embodiment of the present invention installed on an item.

FIG. 5 shows the affordance according to the first embodiment of the present invention installed on an item, where the item is located in a container.

FIG. 6 shows the affordance according to the first embodiment of the present invention in a contracted/folded position.

FIG. 7 shows the contracted/folded affordance according to the first embodiment of the present invention installed on an item.

FIG. 8 shows the contracted/folded affordance according to the first embodiment of the present invention installed on an item, where the item is located in a container.

FIG. 9 shows an exploded view of a container comprising two layers of items. Each layer of items comprise a contracted/folded affordance according to the first embodiment of the present invention installed on an item.

FIG. 10 shows a method of using an affordance to remove an item from a container.

FIG. 11 is a schematic diagram of a framework structure according to a known system.

FIG. 12 is a schematic diagram of a top-down view showing a stack of bins arranged within the framework structure of FIG. 11.

FIGS. 13(a) and 13(b) are schematic perspective views of a load handling device depositing a bin and FIG. 13(c) is a schematic front perspective view of a load handling device lifting a bin.

FIG. 14 is a schematic diagram of a system showing load handling devices operating on the framework structure.

FIGS. 15a and 15b show potential modifications to the affordance according to the first embodiment of the present invention. In these Figures, the affordance is installed on an item.

FIGS. 16a and 16b show further potential modifications to the affordance according to the first embodiment of the present invention. In these Figures, the affordance is installed on an item.

FIG. 17 show a further modification to the affordance according to the first embodiment of the present invention. In this Figure, the affordance is installed on an item.

### DETAILED DESCRIPTION OF EMBODIMENTS

### First Embodiment

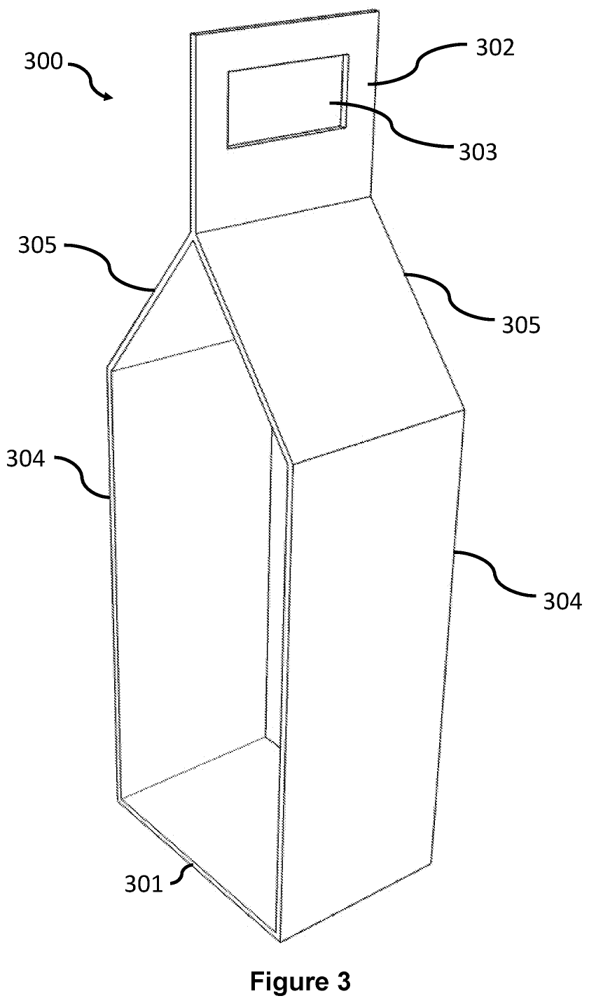

FIG. 3 depicts an affordance 300 according to the first embodiment of the present invention.

The affordance 300 comprises a supporting means 301 and a grasping means 302. The supporting means 301 is arranged to support the weight of an item to be removed from a container. In other words, as shown in FIG. 3, the supporting means may be located underneath an item so that as the item is removed from a container the weight thereof is supported by the supporting means 301. The supporting means 301 is connected to the grasping means 302. As shown in FIG. 3, the supporting means 301 is connected to the grasping means 302 by way of two substantially parallel vertical walls 304. Although, the walls 304 may instead surround the item to be grasped, for example by employing four walls. However, the present inventors have found that by employing only two walls the item can be easily slide on to and off of the affordance 300.

Additionally, the walls 304 may not necessarily be plural and a single wall, of sufficient stiffness may be used to connect the supporting means 301 to the grasping means 302.

In this regard, the present inventors envisage the affordance 300 being formed from a readily bio-degradable material of sufficient strength to support the weight of an item. For example, the affordance 300 may be formed from cardboard. However, if a stiffer material is required to support a heavier item then a plastic material may be used. The present inventors envisage the affordance 300 being formed of other suitable materials depending on the required stiffness, strength and/or durability of the affordance 300 as required by the particular application of the affordance 300.

The walls may optionally connect to the grasping means by way of slanted walls 305 so as to come to together in the middle of the affordance 300 at which point the grasping means 302 is located. In this way, in most situations, the centre of gravity of the item and the grasping position as dictated by the grasping means 302 are aligned which make extraction of the item easier because the item will not tend to tilt as it is removed from the container.

However, the slanted walls 305 are optional and instead the wall 304 may connect directly with the grasping means 302 to thereby form a U-shaped affordance with two grasping means 302, one on either end of the U-shape.

As shown in FIG. 3, the grasping means 302 is envisaged as a location on the affordance which is easily grasped by a human operator and/or a robot system. To this end, the grasping means 302 may be specially shaped to provide an easy grasp for the human operator and/or robot system to increase the speed of picking of items. For example, as shown in FIG. 3 the grasping means 302 may comprise a hand grasp portion 303 which may be useful for a human hand in which fingers can be inserted to grasp, more effectively, the grasping means 302. However, such a hand grasp point 303 may be disadvantageous for a robot system utilising a parallel jaws end effector. Therefore, the grasping means 302 may not include the hand grasp portion 303 and/or include other means by which the parallel jaws end effector can easily grasp the grasping means 302. For example, the grasping means 302 may comprise a structure with at least two substantially parallel surfaces separated by a distance less than the maximum distance between the jaws of the parallel jaws end effector. In this way, effective grasping by the parallel jaws end effector may be achieved. Alternatively, the grasping means 302 may comprise a surface (such a smooth surface) suitable to be gripped by a suction cup end effector. Similarly, the grasping means 302 may comprise a means suitable to be gripped by at least one of parallel jaw grippers, anthropomorphic hand grippers and hook grippers—including a grasping means 302 suitable to be grasped by more than one type of gripper. Similarly, the grasping means 302 may comprise further portions which are particularly suited to perform grasping by other means used by a robot system or a human hand using heavy-duty gloves etc.

Moreover, the grasping means 302 may comprise identification means useful for a human operator and/or a robot system. For example, the grasping means 302 may comprise a black and white pattern and/or a colour to make identification of the grasping means 302 easier for the robot system. In this way, the robot system may more easily locate the affordance 300 in a layer of items and more easily decide how to orientate the robot system (for example, a suction cup end effector or a parallel jaws end effector so as to approach the grasping means 302 in an appropriate direction/angle to ensure an effective grasp of the grasping means 302.

In this way, an item in a tightly packed container may be easily removed by way of the affordance 300.

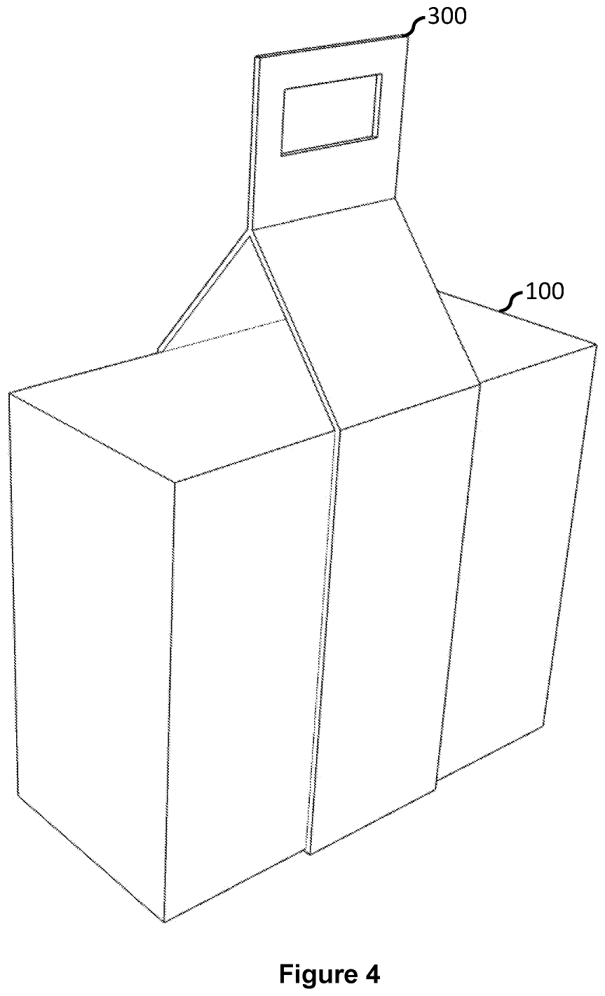

FIG. 4 shows one example of the affordance 300 installed on an item 100. As shown in FIG. 4 the supporting means 301 is located on an underside of the item 100 to thereby support its removal from a container.

As shown in FIG. 4 the affordance 300 may be easily slid onto the item 100 because the affordance 300 comprises two substantially parallel vertical walls 304 to connect the supporting means 301 and the grasping means 302. However, four walls may be used to thereby surround the item but this requires more material, cannot be slid etc. however, it provides better support due to the lateral stability provided by all 4 walls. Optionally, only a single wall may be employed, of sufficient stiffness, to remove the item 100 from a container.

The grasping means 302 extends above a top surface of the item 100 and provides a convenient means by which to grasp the affordance 300 and thereby lift the item 100 from a container. As can be seen in FIG. 4 the top surface of the item 100 is smooth and provides no convenient means by which to remove it from a container. Moreover, when tight packing of items 100 in a container means that the edges of the item 100 will be obstructed by other items and/or the walls of the container, also providing no means by which to grasp the item 100. Therefore, by providing at least one item 100 in a container with the affordance 300 then the item 100 can be easily removed from the container.

FIG. 4 also shows slanted walls 305 between the substantially parallel (and vertical) walls connecting the supporting means 301 to the grasping means 302. The slanted walls 305 may serve two purposes. Firstly, then may ensure that the grasping means 302 is centrally located with respect to the item 100. In this way, for typical items 100 which have a centrally located centre of mass, the centrally located grasping means 302 results in the item staying substantially upright as it is removed from the container, instead of tipping over were the grasping means 302 not located centrally. Secondly, many containers are arranged to ensure a chilling airflow over a top surface of items 100. This is particularly important for grocery items, the temperature of which must be carefully controlled. The slanted walls 305 thereby ensure an unimpeded air gap to maintain chill when the affordance 300 is extended to ensure that temperature control is maintained.

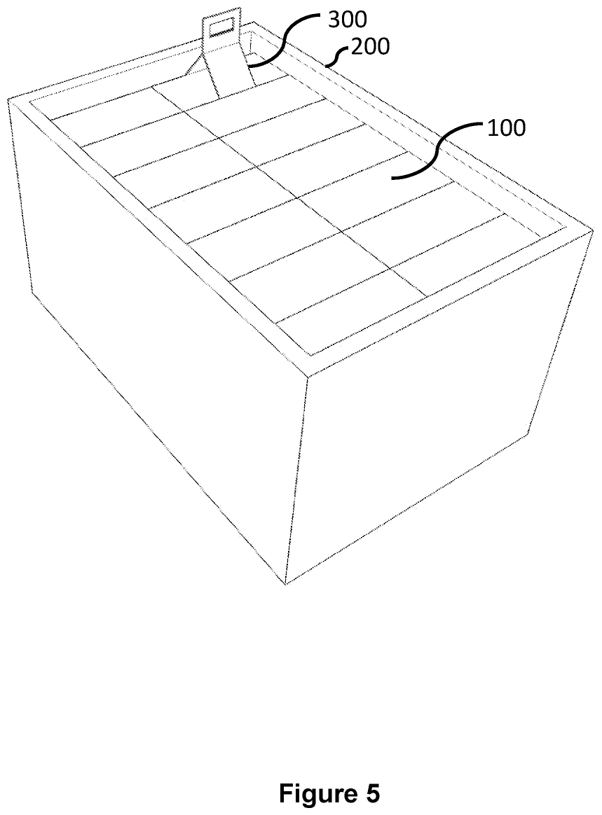

FIG. 5 shows an item 100 upon which an affordance 300 is installed in located in a container 200. Although the affordance 300 is shown to be installed on an item 100 in a corner of the container 200 this need not be the case and the affordance 300 may be installed on any item 100 in the container 200. Therefore, when the container 200 arrives at a location in which at least one item 100 from the container 200 needs to be removed, the human operator/robot system, instead of fumbling to gain a grasp upon an item 100, may simply use the grasping means 302 of the affordance 300 to lift an item 100 out of the container 200. Thereby, having removing one item 100 from the container 200, a space is created in the container 200 from which further items 100 may be removed because a grasping surface of subsequent items 100 is made available by the space created.

Having removed the item 100 from the container 200, the operator/robot system may remove the affordance 300 from the item 100 by sliding the affordance 300 off of the item 100. The affordance 300 may then be reused/recycled.

In this regard, the present inventors consider that the affordance 300 may be installed on an item 100 when the tightly packed container 200 is being packed. For example, the manufacturer of an item 100 may sell items 100 to a reseller/customer. For efficiency in delivery they may tightly pack containers 200 with items 100. Therefore, when the manufacturer is tightly packing items in the container 200 they may install an affordance 300 on at least one item 100 in every layer of items 100 placed in the container 200. In this way, an item 100 from each layer may be easily retrieved when unloading the container 200. Alternatively, the reseller of items may receive items 100 in one type of packaging from a manufacturer, for example, plastic wrapped packaging which may be easily broken to retrieve items therefrom. The reseller may then repack the items 100 in their own warehouse using tightly packed containers from which it may be difficult to remove items 100. Therefore the reseller may install, on at least one item 100 to be placed in a layer in a container 200, the affordance 300 to thereby ensure that when the container 200 is to be unpacked at a later time that unpacking can be achieved easily using the affordance 300.

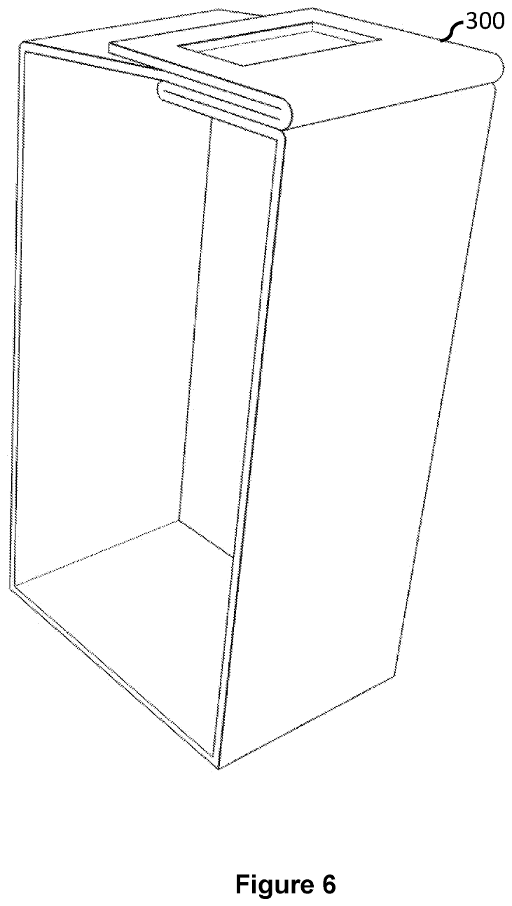

FIG. 6 shows the affordance 300 in a folded position which is useful when transporting the container 200 of items 100 to a destination. Transportation of containers 200 typically require the containers 200 to be of a uniform height so that the containers fit on brackets/hangars of a standard size. Moreover, this maximises space because the containers 200 themselves can be tightly packed together. Therefore, the present inventors have found that, optionally, providing the affordance 300 with a means to collapse in size can be advantageous. In particular, they found that collapsing the grasping means 302 (together with the slanted walls 305) results in a form of affordance 300 that closely follows the contours of the item 100 upon which it is installed. Therefore, the space taken up by the item 100 and affordance 300 is minimally bigger than the item 100 alone. In particular, in the collapsed configuration, the affordance 300 has a smaller height than in its extended position shown previously. In this way, containers 200 can be stacked on top of one another without damaging the grasping means 302 which may otherwise interfere with a bottom of a container 200 in the stack above.

Additionally, when containers 200 contain multiple layers of items 100 then an affordance 300 may be installed on an item 100 in a layer in a collapsed position. In this way, the layers of items may be easily stacked on top of one another, without an extended grasping means 302 interfering with items 100 in the layer above.

To achieve the folded position, the present inventors envisage an affordance 300 formed from a pliable material, such as cardboard, which, even though it can be folded, still maintains its shape. In this way, fold lines may be formed on the affordance 300 around which the slanted walls 305 and the grasping means 302 can fold. Other means by which the grasping means 302 can move to a contracted position are also envisaged.

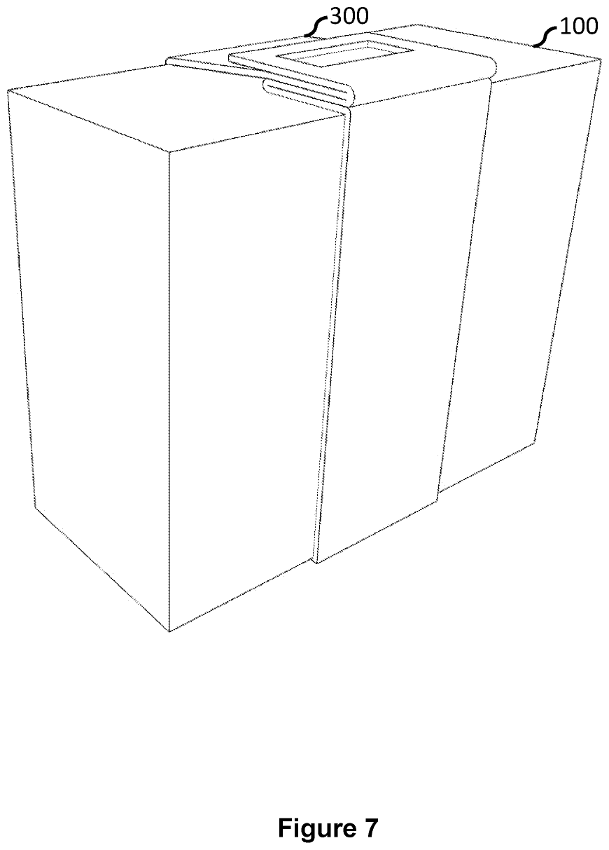

FIG. 7 shows the affordance 300 installed on an item 100. As shown, the affordance 300 is installed in the contracted position. The present inventors envisage that a manufacturer/reseller would install the affordance 300 in a contracted position before transportation/storage in a container. In this way, layers of items 100 could be stored in the container 200 without interference between the layers due to the extended nature of the affordance 300. As shown in FIG. 7 the contours of the item 100 closely match the contours of the affordance 300 thereby maximising the storage of items because they will tessellate well.

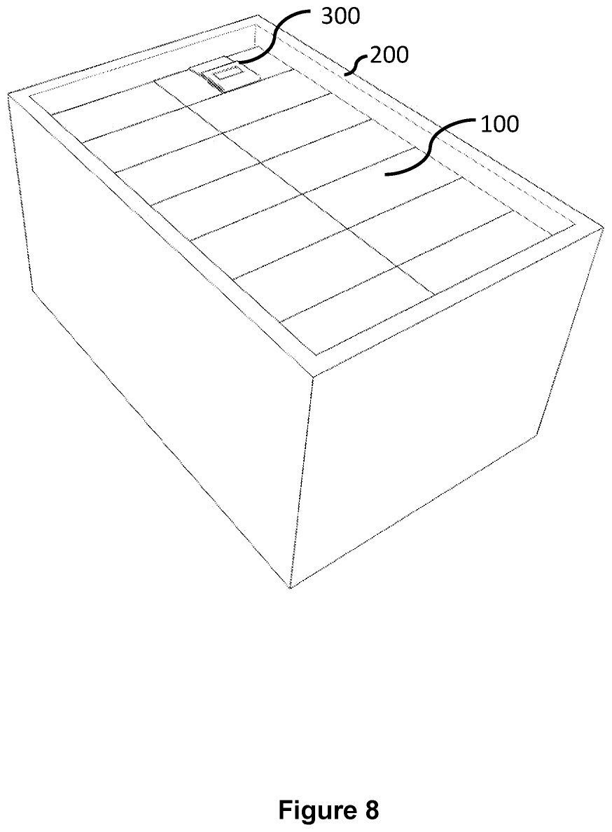

FIG. 8 shows an item 100 comprising an affordance 300, in its collapsed state, as installed in a container 200. When comparing FIG. 5 to FIG. 8 it can be seen that the affordance 300 shown in FIG. 8 assumes less space, vertically, than in FIG. 5. Therefore, containers can be effectively stacked on top of one another without interference.

The present inventors envisage that the pliable nature of the material of the affordance 300 will allow easily extension of the collapsed gripping means 302 from its collapsed state to its extended state. To achieve this, the present inventors envisage a human operator/robot system grasping an edge or surface of the collapsed grasping means 302. The edge is shown somewhat protruded by the surface of the item 100 and therefore may be easily grasped. The pliable nature of the material of the affordance 300 means that as the human operator/robot system pulls on the grasping means 302 it extends from a collapsed position to an extended position. This does not take much force because, at this stage, the weight of the item 100 is not being lifted, instead the extension is merely lifting the weight of the grasping means and the force of the pliable material keeping the grasping means 302 in the collapsed position. Therefore, lifting from a collapsed to extended position requires much less force than lifting the affordance 300 out of the container 200.

Having extended the grasping means 302, the human operator/robot system can lift the item 100 out of the container 200, as described with reference to FIG. 5, by grasping the grasping means 302 and lifting the affordance out of the container 200 which thereby carries the item 100 with it.

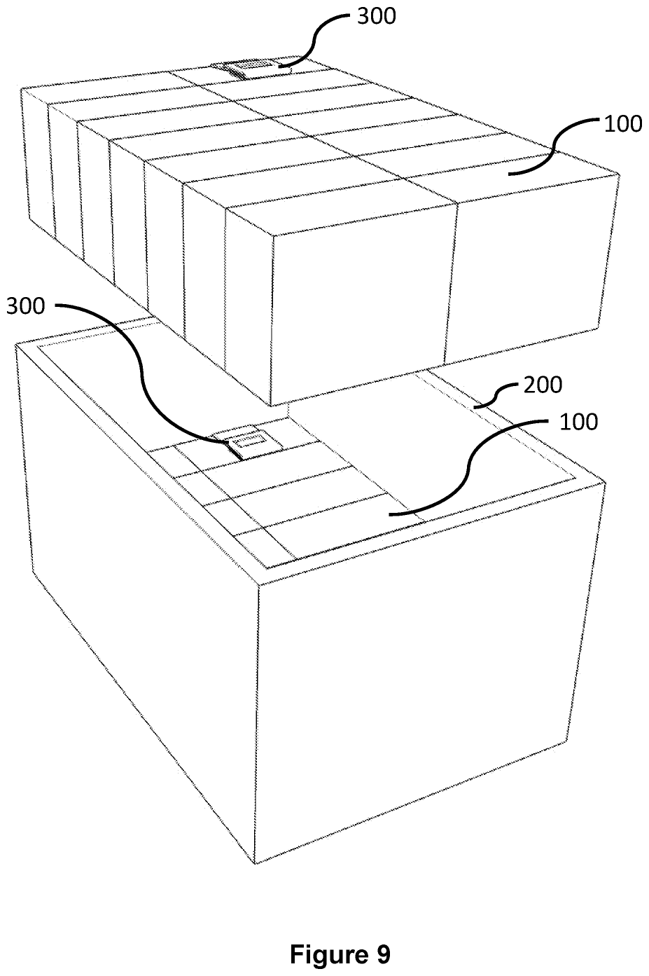

FIG. 9 shows an exploded view of the container 200. As shown, the container 200 comprises two layers of items 100. In this way, the space available in the container for the storage of items 100 is maximised. As shown in FIG. 9, each layer of items 100 in the container 200 comprises an affordance 300. As can be seen, the affordance 300 is arranged in its contracted position. Due to the small gap between the items 100 of the top layer and the items 100 of the bottom layer by providing the affordance 300 on the bottom layer in a contracted position ensures that there is only a small gap between the top and bottom layers of items 300, which may otherwise protrude the top of the container 200 preventing the dense storage of items 100 desired. Therefore, each layer of items 100 in a container comprises at least one affordance 300 to ensure that easier grasping of an item 100 in each layer is achieved. After an item 100 upon which the affordance 300 is installed has been removed from a layer of items 100 then the remaining items 100 can be more easily removed due to the space created by the removal of a first item 100. After all of the items 100 in a top layer of items has been removed from the container 200 then the affordance 300 on the bottom layer may be used to remove an item 100 from the bottom layer. After which, the space created may be used to remove the remaining items from the bottom layer.

In this way, the affordance 300 permits the dense storage of items 100 in a container 200 and the dense storage of containers 200 whilst permitting to easier retrieval of items 100 from the container 200 by way of the affordance 300.

To minimise the gap between layers of items, the affordance 300 may comprise means to permit the effective stacking of affordances 300 when formed in layers. For example, the affordance may comprise a region on the bottom thereof to accept the grasping means 302 of the affordance 300 on the layer below. For example, a cut out in the supporting means 301 of the affordance may be formed to accept the grasping means 302 of another affordance 300. However, to achieve this may require the formation of the affordance 300 from a more resilient material due to the cut out formed in the supporting means 301. In this way, layers of items may more effectively stack with the affordance 300 in one layer not overly interfering with affordances 300 in another layer. Additionally or alternatively, the affordances 300 may be arranged in respective layers offset from one another, in other words located on different items 100 in the layers to that affordances 300 do not directly stack on top of each other.

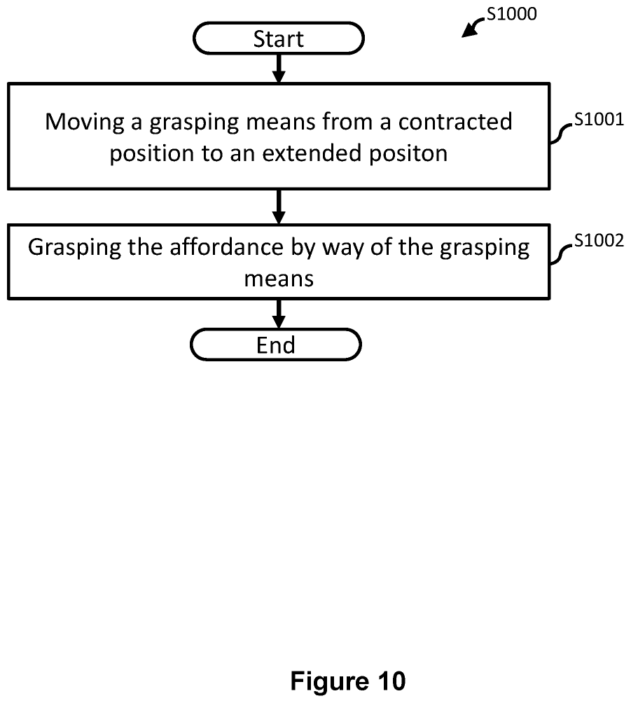

FIG. 10 is a flowchart showing a method 51000 performed to remove an item from a container by way of an affordance according to the first embodiment of the present invention.

The affordance comprises a grasping means and a supporting means. At step S1001, the grasping means of the affordance is moved from a contracted/collapsed position to an extended position. This is achieved by way of a human operator/robot system grasping an edge or surface of the grasping means and moving it, against gravity and a retaining force, to an extended position. For example, the affordance may be secured in its collapsed position during transport of a container comprising a plurality of items. An item in the container may comprise the affordance. To prevent interference with other containers/items, the affordance may be stowed in a collapsed position to more closely follow the contours of the item upon which it is installed.

At step S1002, the affordance is grasped by way of the grasping means. In this way, a sufficient grasp of the affordance is achieved which, in turn, permits the removal of the item (upon which the affordance is installed) from the container. To achieve this a human operator/robot system grasps the affordance by way of the grasping means and then lifts the affordance out of the container. A supporting means on the affordance supports the weight of the item permitting its removal from the container.

As explained previously, the present inventors envisage that the manufacturer/reseller of the item may install the affordance when packing the container densely with items. For example, the manufacturer may install the affordance before shipping a container of items to a customer. The customer may remove the affordance once its use of permitting the easy removal of an item from a container has been served.

Modifications and Variations

Many modifications and variations can be made to the embodiments described above, without departing from the scope of the present invention.

Online retail businesses selling multiple product lines, such as online grocers and supermarkets, require systems that are able to store tens or even hundreds of thousands of different product lines. The use of single-product stacks in such cases can be impractical, since a very large floor area would be required to accommodate all of the stacks required. Furthermore, it can be desirable only to store small quantities of some items, such as perishables or infrequently-ordered goods, making single-product stacks an inefficient solution.

International patent application WO 98/049075A (Autostore), the contents of which are incorporated herein by reference, describes a system in which multi-product stacks of containers are arranged within a frame structure.

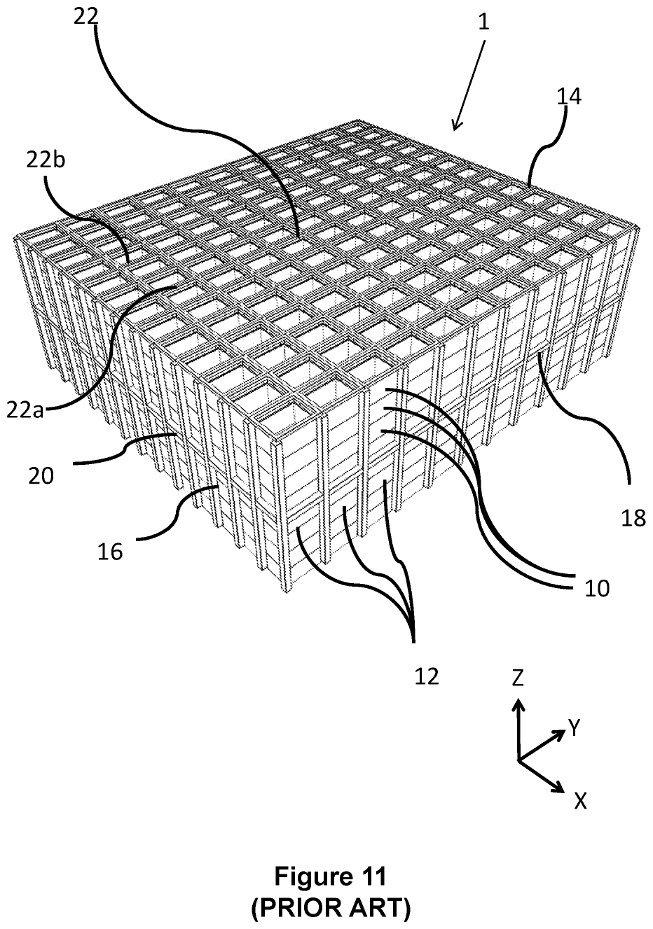

PCT Publication No. WO2015/185628A (Ocado) describes a further known storage and fulfilment system in which stacks of bins or containers are arranged within a framework structure. The bins or containers are accessed by load handling devices operative on tracks located on the top of the frame structure. The load handling devices lift bins or containers out from the stacks, multiple load handling devices co-operating to access bins or containers located in the lowest positions of the stack. A system of this type is illustrated schematically in FIGS. 11 to 14 of the accompanying drawings.

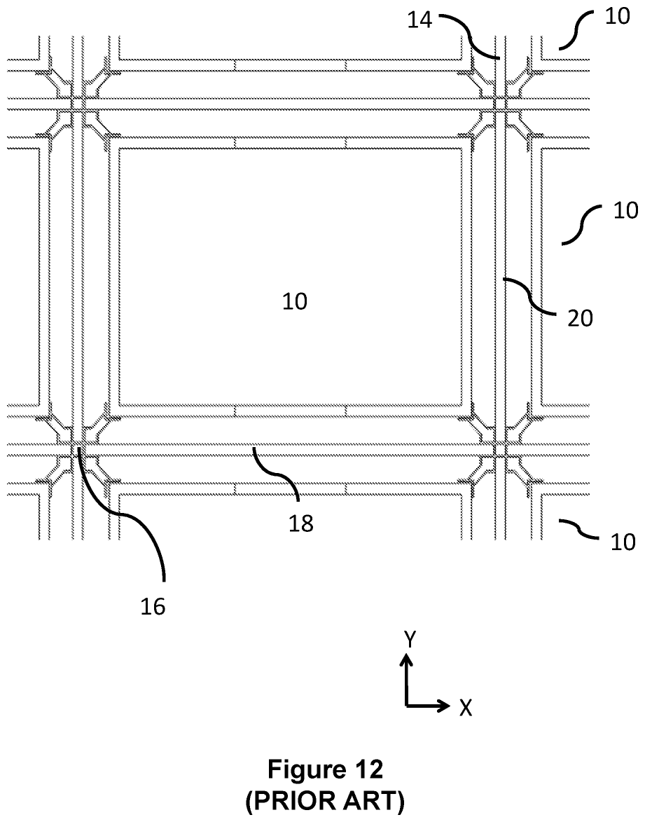

As shown in FIGS. 11 and 12, stackable containers, known as bins 10, are stacked on top of one another to form stacks 12. The stacks 12 are arranged in a grid framework structure 14 in a warehousing or manufacturing environment. FIG. 11 is a schematic perspective view of the framework structure 14, and FIG. 12 is a top-down view showing a stack 12 of bins 10 arranged within the framework structure 14. Each bin 10 typically holds a plurality of product items (not shown), and the product items within a bin 10 may be identical, or may be of different product types depending on the application.

The framework structure 14 comprises a plurality of upright members 16 that support horizontal members 18, 20. A first set of parallel horizontal members 18 is arranged perpendicularly to a second set of parallel horizontal members 20 to form a plurality of horizontal grid structures supported by the upright members 16. The members 16, 18, 20 are typically manufactured from metal. The bins 10 are stacked between the members 16, 18, 20 of the framework structure 14, so that the framework structure 14 guards against horizontal movement of the stacks 12 of bins 10, and guides vertical movement of the bins 10.

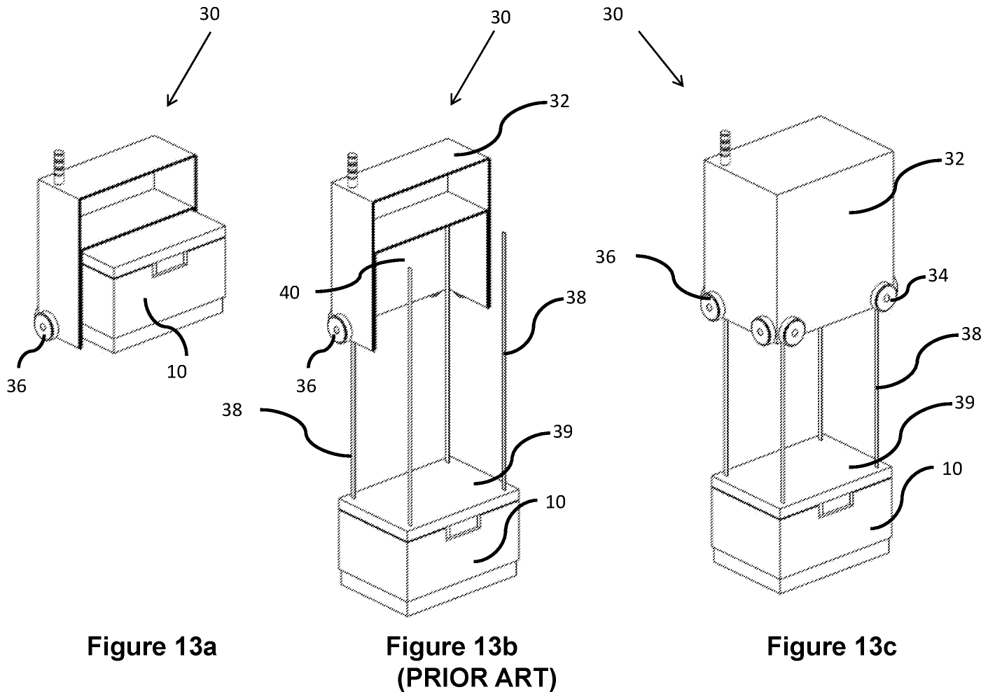

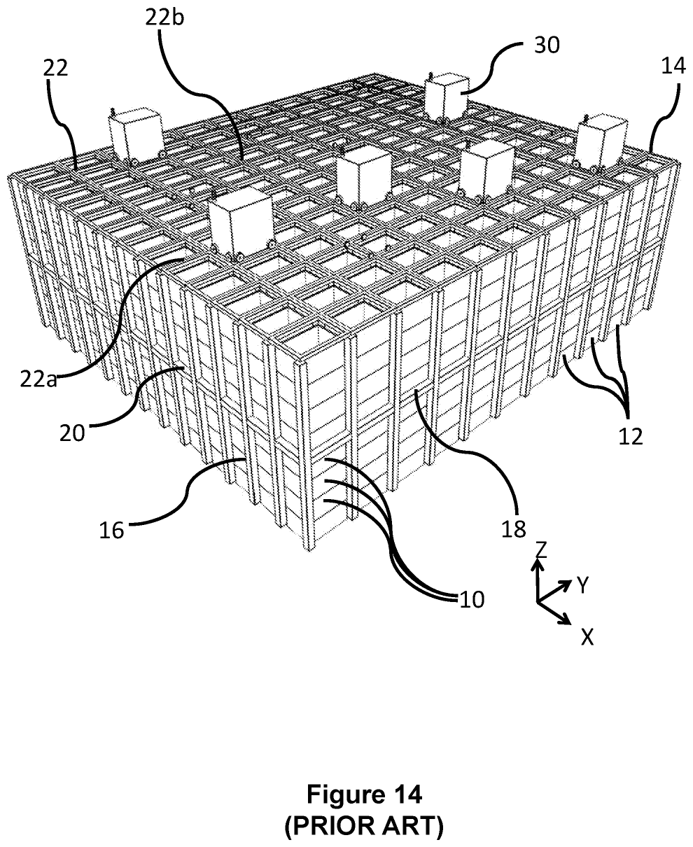

The top level of the frame structure 14 includes rails 22 arranged in a grid pattern across the top of the stacks 12. Referring additionally to FIGS. 13 and 14, the rails 22 support a plurality of robotic load handling devices 30. A first set 22a of parallel rails 22 guide movement of the load handling devices 30 in a first direction (for example, an X-direction) across the top of the frame structure 14, and a second set 22b of parallel rails 22, arranged perpendicular to the first set 22a, guide movement of the load handling devices 30 in a second direction (for example, a Y-direction), perpendicular to the first direction. In this way, the rails 22 allow movement of the load handling devices 30 laterally in two dimensions in the horizontal X-Y plane, so that a load handling device 30 can be moved into position above any of the stacks 12.

One form of load handling device 30 is further described in Norwegian patent number 317366, the contents of which are incorporated herein by reference. FIGS. 13(a) and 13(b) are schematic cross sectionals views of a load handling device 30 depositing a bin 10, and FIG. 13(c) is a schematic front perspective view of a load handling device 30 lifting a bin 10. However, there are other forms of load handling device that may be used in combination with the system herein described. For example a further form of robotic load handling device is described in PCT Patent Publication No. WO2015/019055, hereby incorporated by reference, (Ocado) where each robotic load handler only covers one grid space of the frame work structure, thus allowing higher density of load handlers and thus higher throughput for a given sized system.

Each load handling device 30 comprises a vehicle 32 which is arranged to travel in the X and Y directions on the rails 22 of the frame structure 14, above the stacks 12. A first set of wheels 34, consisting of a pair of wheels 34 on the front of the vehicle 32 and a pair of wheels 34 on the back of the vehicle 32, is arranged to engage with two adjacent rails of the first set 22a of rails 22. Similarly, a second set of wheels 36, consisting of a pair of wheels 36 on each side of the vehicle 32, is arranged to engage with two adjacent rails of the second set 22b of rails 22. Each set of wheels 34, 36 can be lifted and lowered, so that either the first set of wheels 34 or the second set of wheels 36 is engaged with the respective set of rails 22a, 22b at any one time.

When the first set of wheels 34 is engaged with the first set of rails 22a and the second set of wheels 36 is lifted clear from the rails 22, the wheels 34 can be driven, by way of a drive mechanism (not shown) housed in the vehicle 32, to move the load handling device 30 in the X direction. To move the load handling device 30 in the Y direction, the first set of wheels 34 is lifted clear of the rails 22, and the second set of wheels 36 is lowered into engagement with the second set of rails 22a. The drive mechanism can then be used to drive the second set of wheels 36 to achieve movement in the Y direction.

The load handling device 30 is equipped with a lifting device. The lifting device 40 comprises a gripper plate 39 is suspended from the body of the load handling device 32 by four cables 38. The cables 38 are connected to a winding mechanism (not shown) housed within the vehicle 32. The cables 38 can be spooled in or out from the load handling device 32, so that the position of the gripper plate 39 with respect to the vehicle 32 can be adjusted in the Z direction.

The gripper plate 39 is adapted to engage with the top of a bin 10. For example, the gripper plate 39 may include pins (not shown) that mate with corresponding holes (not shown) in the rim that forms the top surface of the bin 10, and sliding clips (not shown) that are engageable with the rim to grip the bin 10. The clips are driven to engage with the bin 10 by a suitable drive mechanism housed within the gripper plate 39, which is powered and controlled by signals carried through the cables 38 themselves or through a separate control cable (not shown).

To remove a bin 10 from the top of a stack 12, the load handling device 30 is moved as necessary in the X and Y directions so that the gripper plate 39 is positioned above the stack 12. The gripper plate 39 is then lowered vertically in the Z direction to engage with the bin 10 on the top of the stack 12, as shown in FIG. 13(c). The gripper plate 39 grips the bin 10, and is then pulled upwards on the cables 38, with the bin 10 attached. At the top of its vertical travel, the bin 10 is accommodated within the vehicle body 32 and is held above the level of the rails 22. In this way, the load handling device 30 can be moved to a different position in the X-Y plane, carrying the bin 10 along with it, to transport the bin 10 to another location. The cables 38 are long enough to allow the load handling device 30 to retrieve and place bins from any level of a stack 12, including the floor level. The weight of the vehicle 32 may be comprised in part of batteries that are used to power the drive mechanism for the wheels 34, 36.

As shown in FIG. 14, a plurality of identical load handling devices 30 are provided, so that each load handling device 30 can operate simultaneously to increase the throughput of the system.

The system illustrated in FIG. 14 may include specific locations, known as ports, at which bins 10 can be transferred into or out of the system. An additional conveyor system (not shown) is associated with each port, so that bins 10 transported to a port by a load handling device 30 can be transferred to another location by the conveyor system, for example to a picking station (not shown). Similarly, bins 10 can be moved by the conveyor system to a port from an external location, for example to a bin-filling station (not shown), and transported to a stack 12 by the load handling devices 30 to replenish the stock in the system.

Each load handling device 30 can lift and move one bin 10 at a time. If it is necessary to retrieve a bin 10 (“target bin”) that is not located on the top of a stack 12, then the overlying bins 10 (“non-target bins”) must first be moved to allow access to the target bin 10. This is achieved in an operation referred to hereafter as “digging”.

Referring to FIG. 14, during a digging operation, one of the load handling devices 30 sequentially lifts each non-target bin 10a from the stack 12 containing the target bin 10b and places it in a vacant position within another stack 12. The target bin 10b can then be accessed by the load handling device 30 and moved to a port 24 for further transportation.

Each of the load handling devices 30 is under the control of a central computer. Each individual bin 10 in the system is tracked, so that the appropriate bins 10 can be retrieved, transported and replaced as necessary. For example, during a digging operation, the locations of each of the non-target bins 10a is logged, so that the non-target bins 10a can be tracked.

The system described with reference to FIGS. 11 to 14 has many advantages and is suitable for a wide range of storage and retrieval operations. In particular, it allows very dense storage of product, and it provides a very economical way of storing a huge range of different items in the bins 10, while allowing reasonably economical access to all of the bins 10 when required for picking.

However, there are some drawbacks with such a system, which all result from the above-described digging operation that must be performed when a target bin 10b is not at the top of a stack 12.

Moreover, to maximise the space available in the bins 10 for storing items, items may be packed densely in each bin 10, sometimes forming multiple layers of items such as shown in FIG. 9.

Therefore, to solve the problem of easily retrieving items from the bin 10, an affordance 300 according to the first embodiment of the present invention may be installed on an item of each layer of items stored in the bin 10. In this way, retrieval of the item from the bin can be more easily achieved, together with easier retrieval of subsequent items from the layer in the bin 10 due to the additional space formed in the bin 10 by the removal of the first item. The bin 10 may be delivered to a picking station (not shown) where a human operator/robot system may be employed to retrieve at least one item from the bin 10. As explained, by way of the affordance 300, easier picking of the first item from the bin 10 can be achieved for the human operator/robot system. The affordance 300, having served its function, may be removed from the item by the human operator/robot system at the picking station so as not to transport the affordance to a customer.

In such a system, it is envisaged that the system is used by a reseller to pick items for customers. The affordance 300 may be installed on a single item in a layer of items by a manufacturer of the items which may be transported to the reseller in a container, such as an IFCO. The IFCO may then be placed, as a whole, in the bin 10. Accordingly, the affordance 300 may be used by an operator/robot system at a pick station to pick an item from an IFCO, which is itself placed in a bin 10.

Alternatively, the contents of the IFCO (or container in which the items are transported from a manufacturer) may be broken down by a human operator/robot system at a decanting station (not shown) whereby the items from the container/IFCO may be placed in the bin 10. Therefore, the operator/robot system may extract the items from the IFCO/container and place them in the bin 10. To extract the items, the operator/robot system may use the affordance 300 located on an item in the IFCO/container to easily remove items before placing them in the bin 10. The operator/robot system may densely pack the bin 10 with the items from the container/IFCO. In which case, the affordance may again be used by a human operator/robot system at the picking station (not shown) to effectively remove an item from the densely packed bin 10. Alternatively, where the items to be placed in a bin 10 do not already have an affordance 300 installed thereon, the human operator/robot system may install an affordance 300 on at least one item for dense storage in the bin 10 and then densely pack the bin 10 with items ensuring that at least one affordance 300 is available in each layer of items in the bin 10. Alternatively, the operator/robot system at the decanting station may loosely pack the items in the bin 10 which allows easy grasping of items by an operator/robot system at a pick station. Accordingly, the operator/robot system at the decanting station may remove the affordance (which may be subsequently reused/recycled) having served its function.

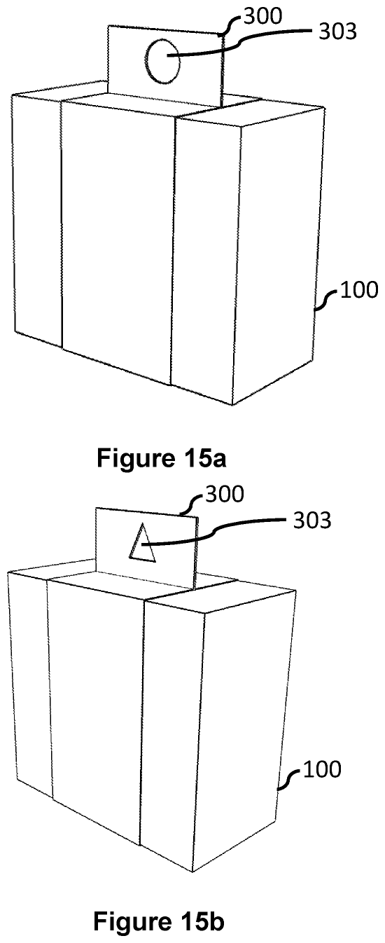

FIGS. 15a and 15b show further modifications and variations to the affordance 300 for use in different environments. In particular the hand grasp portion 303 may be modified for grasping by other means other than a hand, for example, a robot gripper. In particular, there may be an advantage to have a hand grasp portion 303 which is shaped to interface well with the robot gripper. For instance, the gripper of a robot may be circularly, cylindrically, or triangularly, pyramidically shaped. Therefore, as shown in FIG. 15a, the hand grasp portion 303 may be circularly shaped to best interface with a circular or cylindrically shaped gripper. Similarly, FIG. 15b shows a hand grasp portion 303 which is triangularly shaped so as to best interface with a triangularly or pyramidically shaped gripper.

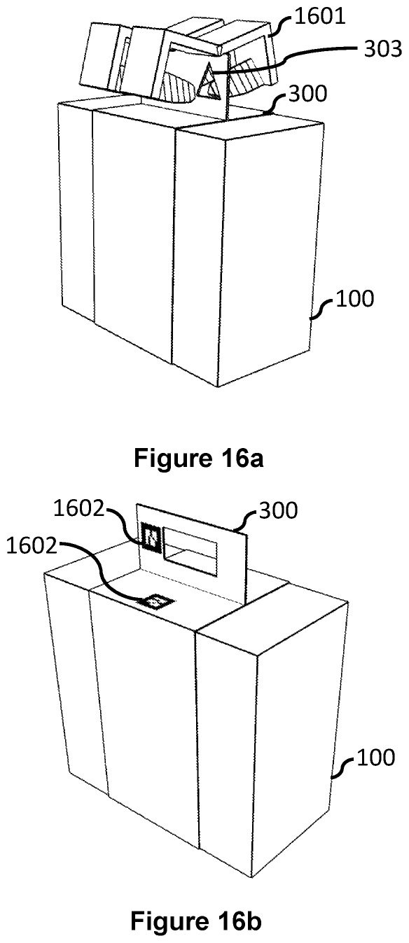

FIG. 16a shows an example of a robot gripper 1601 which has pyramidically shaped “fingers”. Therefore, the affordance 300 has at least one hand grasp portion 303 which is triangularly shaped. Therefore, the gripper 1601 will engage better with more stability. Optionally, more than one hand grasp portion 303 may be provided on the affordance to increase the stability of the grasp of the affordance 300.

FIG. 16b shows a modification of applying at least one marking 1602 onto the affordance 300. In this example, the marking 1602 is a QR code. The use of a marking 1602 makes it easier to localise the affordance 300 particularly when using computer vision techniques. Moreover, the marking 1602 may be used to convey information to a picking system using a robot/human gripper to pick the item 100 from the container 200. For example, the marking 1602 may convey at least one of, item identification information, date code information or the like. It could be referenced rather than encoded, for example, having a static code that is read and referenced to a database by the picking system. The static code may be used to track information about the affordance 300 as it is reused more than once. For example, tracking that the affordance 300 has been used a predetermined number of time and therefore needs replacement or washing.

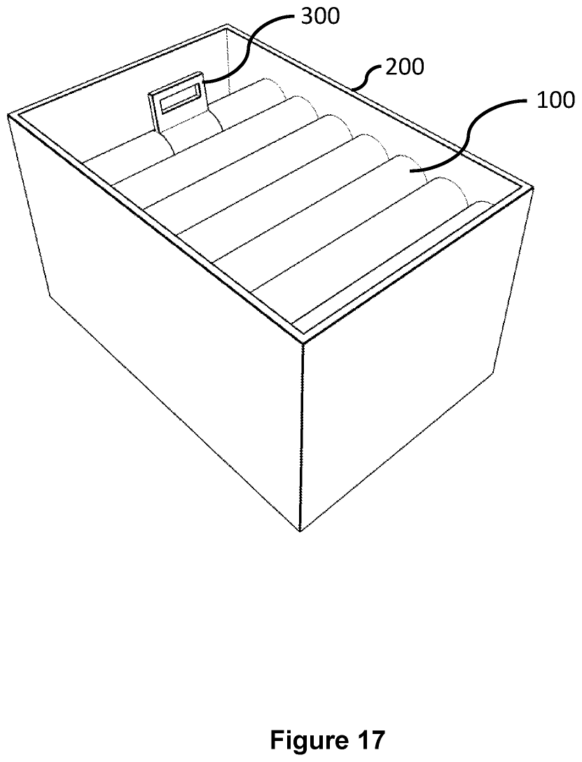

FIG. 17 shows a further modification. It is envisaged that the affordance 300 described herein may be applied to any differently shaped objects, not a simple cuboid object depicted. Therefore, FIG. 17 shows the example application of the affordance 300 to tubular/cylindrical objects 100. For example, a container 200 comprising tubes stacked horizontally which might be difficult for a robot/human to grasp the first of, but with the affordance 300 described herein would be simpler.

Although the description refers to the item 100 to be picked as singular. However, it is envisaged that there may be a need or an advantage to apply the affordance 300 to several items in a container 200. To this end, a container 100 may comprise two or more affordances, where each affordance is applied to a different item 100. For example, a container 200 may comprise a first affordance applied to a first item 100 and a second affordance applied to a second item 200. Alternatively or additionally, a container 200 may comprise a first affordance 300 to more than one item. In other words, the first affordance 300 may be applied to both a first item 100 and a second item 100. In this way, grasping and extracting the first affordance 300 from the container 200 results in the extraction of the first item and second item from the container 200.

The foregoing description of embodiments of the invention has been presented for the purpose of illustration and description. It is not intended to be exhaustive or to limit the invention to the precise form disclosed. Modifications and variations can be made without departing from the spirit and scope of the present invention.

1. An affordance for an item to be grasped, the item being arranged to be stored in a container, the affordance comprising:
a supporting means configured and arranged to support at least a portion of the item to be grasped; and
a grasping means configured and arranged to be grasped.

2. The affordance according to claim 1, wherein the grasping means is configured and arranged to move between a first position and a second position.

3. The affordance according to claim 2, wherein the first position is a contracted position and the second position is an extended position.

4. The affordance according to claim 3, wherein the grasping means is configured and arranged to be positioned in the contracted position during transport of a container.

5. The affordance according to claim 3, wherein the grasping means is configured and arranged to be positioned in the extended position during and/or after picking of an item from a container.

6. The affordance according to claim 1, wherein the grasping means is configured and arranged to be grasped by an operator and/or a robot system.

7. The affordance according to claim 1, wherein the affordance is formed from a bio-degradable material.

8. The affordance according to claim 1, wherein the affordance is configured and arranged to be installed on an item by a manufacturer of the item.

9. The affordance according to claim 1, wherein the affordance is configured and arranged to be removable from an item by an operator and/or a robot system.

10. The affordance according to claim 1, in combination with a container, wherein the container comprises:
a plurality of items, and the affordance is configured and arranged to be installed on a single item of the plurality of items in the container.

11. The affordance according to claim 1, wherein the affordance is configured and arranged to be installed on an item stored in an International Fruit Container, IFCO.

12. A storage system comprising:
a first set of parallel rails or tracks extending in an X-direction, and a second set of parallel rails or tracks extending in a Y-direction transverse to the first set in a substantially horizontal plane to form a grid pattern having a plurality of grid spaces;
a plurality of stacks of containers located beneath the rails, and arranged such that each stack is located within a footprint of a single grid space; and
at least one transporting device, the at least one transporting device being configured and arranged to move in the X and/or Y directions, above the stacks,
wherein a container of the plurality of stacks of containers is arranged to contain at least one item and at least one affordance according to claim 1, wherein the at least one affordance is installed on the at least one item.

13. The storage system according to claim 12, wherein the at least one transporting device has a footprint that occupies only a single grid space in the storage system, such that a transporting device occupying one grid space will not obstruct a transporting device occupying or traversing the adjacent grid spaces in the X and Y directions.

14. A method of using an affordance having a supporting means and a grasping means, the affordance being installed on an item to be grasped, the item being arranged to be stored in a container, the method comprising:
moving the grasping means from a contracted position to an extended position; and
grasping the affordance by way of the grasping means.

15. The method according to claim 13, comprising:
arranging the grasping means to be positioned in the contracted position during transport of the container.

16. The method according to claim 13, comprising:
performing the grasping by an operator and/or a robot system.

17. The method according to claim 13, comprising:
installing the affordance on the item.

18. The method according to any of claim 16, further comprising the step of:
installing the affordance on a single item in a container comprising a plurality of items.

19. The method according to claim 13, comprising:
removing the affordance from the item.
